(19) United States
(12) Patent Application Publication
(10) Pub. No.: US 2019/0278238 A1
(43) Pub. Date: Sep. 12, 2019

(54) Control system and method for script authoring and remote activation

(71) Applicant: Gershon P. Ouano, Jersey City, NJ (US)

(72) Inventor: Gershon P. Ouano, Jersey City, NJ (US)

(21) Appl. No.: 15/918,826

(22) Filed: Mar. 12, 2018

(51) Int. Cl. G05B 15/02; H04L 29/08

(52) U.S. Cl. CPC G05B 15/02; H04L 67/125

(57) ABSTRACT

A control system for script authoring and remote activation includes a control system server, including a processor, a non-transitory memory, a script editor, a script executor; and a remote activation device with a button, such that the control system server executes a control script, when a button activation signal is transmitted to the control system server, when the button is depressed by a user. Also disclosed is a method, including editing, remotely activating, and executing a control script.

### CROSS-REFERENCE TO RELATED APPLICATIONS

N/A.

### FIELD OF THE INVENTION

The present invention relates generally to the field of computer control systems, and more particularly to methods and systems for controlling the execution of a predetermined script via remote script activation.

### BACKGROUND OF THE INVENTION

User of personal computers often have a need to control functions of their home computer when not in direct proximity of the computer.

Complex programs for remote control are available to control a computer from remote locations. Such programs allow control of all function by emulating the entire graphical user interface of the home computer. However, these programs are complex in use, are often not well-suited for mobile devices, and do not support set-up of script-based automation.

As such, considering the foregoing, it may be appreciated that there continues to be a need for novel and improved devices and methods for script authoring and remote activation of computers.

### SUMMARY OF THE INVENTION

The foregoing needs are met, to a great extent, by the present invention, wherein in aspects of this invention, enhancements are provided to the existing model of remote control of computers.

In an aspect a control system for script authoring and remote activation can include:
a) a control system server;
b) a remote activation device that includes a button;
such that the control system server is configured with a control script, such that the control script executes a function on the control system server;
such that a button activation signal is transmitted to the control system server, when the button is depressed by the user;
such that the control system server executes at least one function when the button activation signal is received by the control system server.

In a related aspect, the control system can further include:
a wireless receiver;
such that the remote activation device communicates with control system server via the wireless receiver.

In a further related aspect, the wireless receiver can be a part of the control system server.

In another related aspect, the control system server can further include:
a) a processor;
b) a non-transitory memory;
c) an input/output component; and
d) a script editor, which is configured to allow a user to create, edit, and save the control script.

In a further related aspect, the control system server can further include:
a script executor, which is configured to executes the control script when a button activation signal is received by the control system server, such that the control system server executes a function.

In a related aspect, the function can include restarting the control system server.

In a related aspect, the function can include turning off the control system server.

In a related aspect, the function can include executing a selected application.

In a related aspect, the function can include closing selected processes.

In a related aspect, the function can include playing an audio file.

In a related aspect, the function can include playing an audio file.

In a further related aspect, the audio file can be configured to play a doorbell sound.

There has thus been outlined, rather broadly, certain embodiments of the invention in order that the detailed description thereof herein may be better understood, and in order that the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. In addition, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1A is a schematic diagram illustrating a control system for script authoring and remote activation, according to an embodiment of the invention.

FIG. 1B is a schematic diagram illustrating a control system for script authoring and remote activation, according to an embodiment of the invention.

FIG. 2 is a schematic diagram illustrating a script authoring and remote activation server, according to an embodiment of the invention.

FIG. 3 is a schematic diagram illustrating a remote activation device, according to an embodiment of the invention.

FIG. 4 is an illustration of a graphical user interface for script authoring, according to an embodiment of the invention.

FIG. 5A is a front view of a remote activation device with one button only, according to an embodiment of the invention.

FIG. 5B is a rear view of a remote activation device with pressure sensitive adhesive, according to an embodiment of the invention.

FIG. 5C is a perspective view of a remote activation device during handheld use, according to an embodiment of the invention.

FIG. 6 is a flowchart illustrating steps that may be followed, in accordance with one embodiment of a method or process for script authoring and remote activation.

### DETAILED DESCRIPTION

Before describing the invention in detail, it should be observed that the present invention resides primarily in a novel and non-obvious combination of elements and process steps. So as not to obscure the disclosure with details that will readily be apparent to those skilled in the art, certain conventional elements and steps have been presented with lesser detail, while the drawings and specification describe in greater detail other elements and steps pertinent to understanding the invention.

The following embodiments are not intended to define limits as to the structure or method of the invention, but only to provide exemplary constructions. The embodiments are permissive rather than mandatory and illustrative rather than exhaustive.

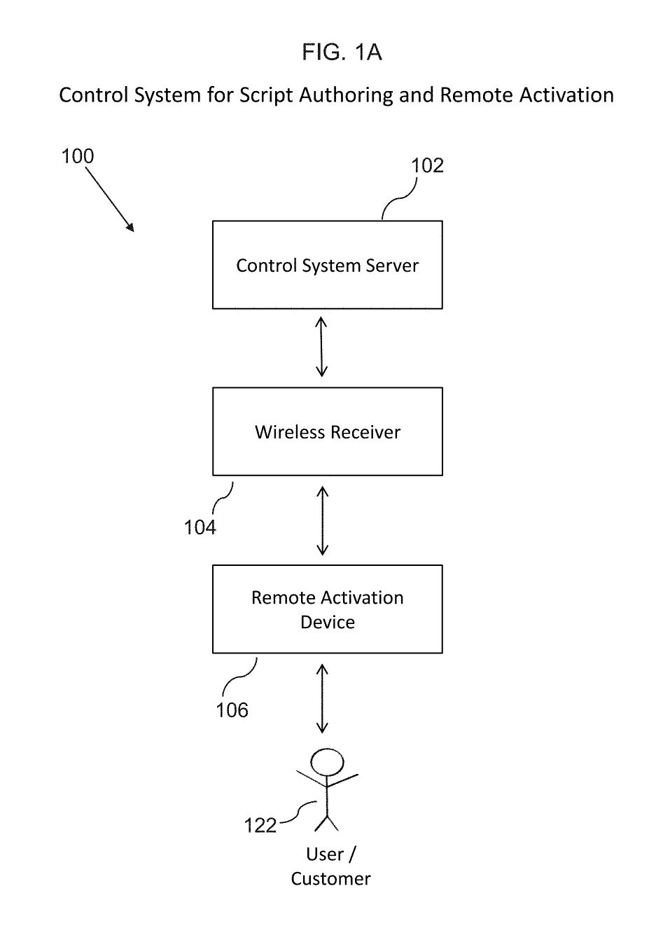

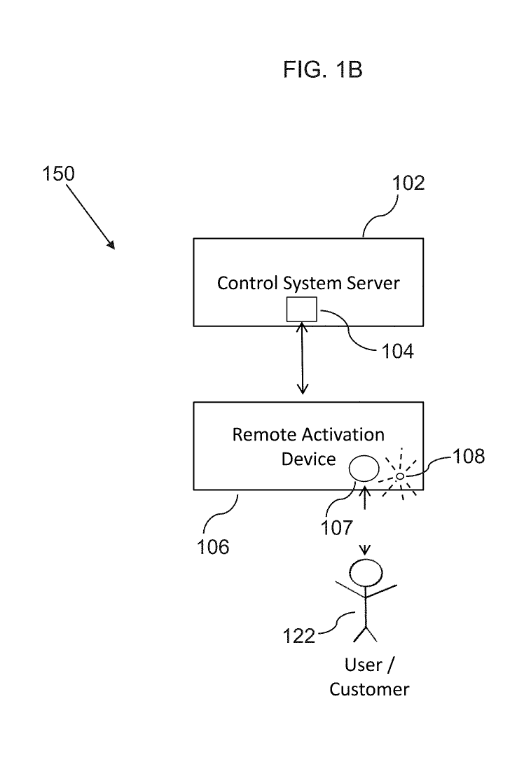

In the following, we describe the structure of an embodiment of a control system for script authoring and remote activation 100 with reference to FIG. 1A, in such manner that like reference numerals refer to like components throughout; a convention that we shall employ for the remainder of this specification.

In an embodiment, a control system for script authoring and remote activation 100 can include:
a) a control system server 102;
b) a wireless receiver 104; and
c) a remote activation device 106 that includes, at least one button 107;
wherein the control system server 102 can be configured with a predetermined control script, such that the predetermined control script executes a function on the control system server 102, wherein the function can for example be playing an audio signal that sounds like a door bell, opening a specific program, executing a script of commands, etc.;
wherein a button activation signal is transmitted to the control system server 102, via the wireless receiver 104, when the at least one button 107 is depressed by the user 122;
such that the control system server 102 executes the function when the button activation signal is received by the control system server 102.

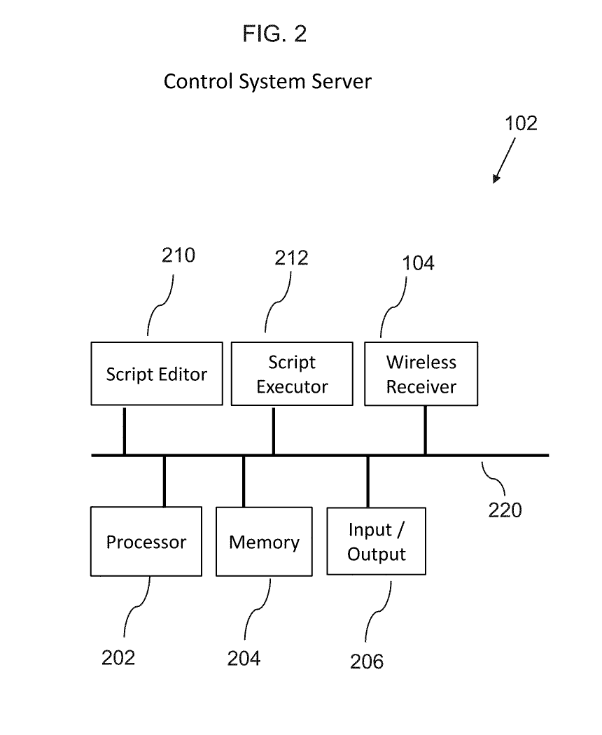

In a related embodiment, as shown in FIG. 2 the wireless receiver 104 can be a part of the control system server 102.

In another related embodiment, the remote activation device 106 can further include a light source 108, such as a light bulb 108, or light emitting diode (LED) 108, which can emit a light signal from the light source 108, when the user 122 presses the button 107. The light source 108 can for example be configured as an LED that emits green light.

In a related embodiment, as shown in FIG. 2, a control system server 102 can include:
a) A processor 202;
b) A non-transitory memory 204;
c) An input/output component 206;
d) A script editor 210, which can be configured to allow a user 122 to create, edit, and save a control script, such that the control script can be configured to execute at least one function on the control system server 102;
e) A script executor 212, which can be configured to execute the control script when a button activation signal is received by the control system server, such that the control system server 102 executes the at least one function; and
f) A wireless receiver 104, which is configured to receive a button activation signal in communication with the remote activation device 106, when the at least one button 107 is depressed by the user 122; all connected via
g) A data bus 220.

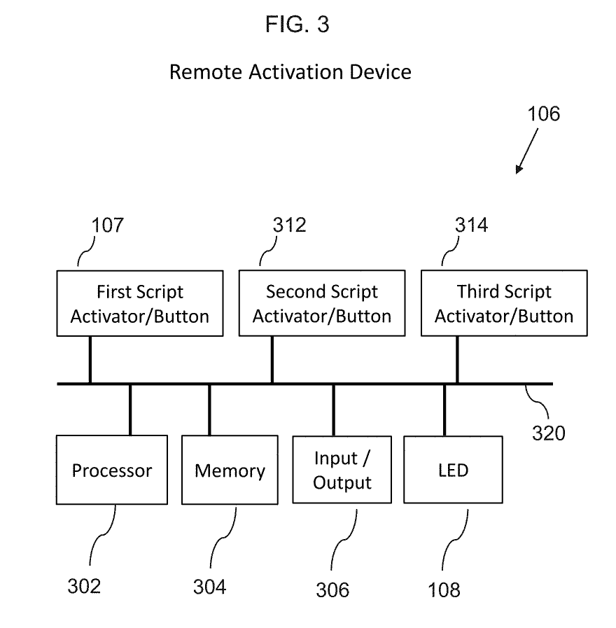

In a related embodiment, as shown in FIG. 3, a remote activation device 106 can include:
a) A processor 302;
b) A non-transitory memory 304;
c) An input/output 306;
d) At least one button 107, also called a first script activator/button 107;
e) (optionally) a second script activator/button 312; and
f) (optionally) A third script activator/button 314; all connected via
g) A data bus 320;
Wherein the control system server is configured with first, second, and third control scripts that are associated with respectively the first, second, and third buttons.

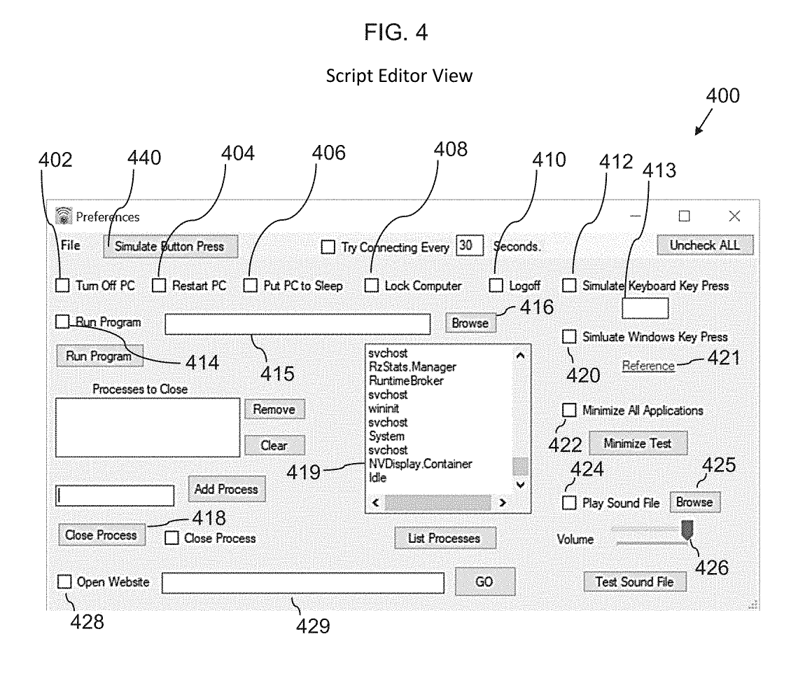

In an embodiment, the script editor can be configured to allow a user 122 to create, edit, and save a control script, for example as shown in FIG. 4 via a script editor view/window 400, such that the control script is configured to execute at least one function on the control system server 102, wherein the at least one function can include:
a) Turning of PC 402;
b) Restarting PC 404;
c) Putting PC to Sleep 406;
d) Locking Computer 408;
e) Logging Active User Off 410;
f) Simulating keyboard button press/activation 412, allowing the user 122 to type the button or string of characters to be simulated into a string input field 413;
g) Executing an application 414, allowing the user 122 to type an application path and application name to be executed into an application input field 415 or selecting an application via an application browse function 416;
h) Closing processes 418, allowing the user 122 to select processes to be closed by selecting the processes from a list 419;
i) Simulating Windows Key press/activation 420, allowing the user 122 to select the key from a key reference list 421;
j) Minimize all application windows 422;
k) Playing a sound/audio file 424, allowing the user 122 to select an audio file via an audio file browse function 425, and optionally select a playback volume 426;
l) Opening a website 428, allowing the user 122 to type a website uniform resource locator (URL) to be opened into a website input field 429; or
m) A combination of these.

In a related embodiment, the script editor 210 can be configured to allow a user 122 to do a test execution of the selected functions, by pressing a simulation button 440 on control system server 102, such that depressing the simulation button 440 simulates script activation from activation of a button 107 on a remote activation device 106. Simulation of script activation can be an actual execution of the selected function on the control system server 102, or it can be a simulated/emulated execution.

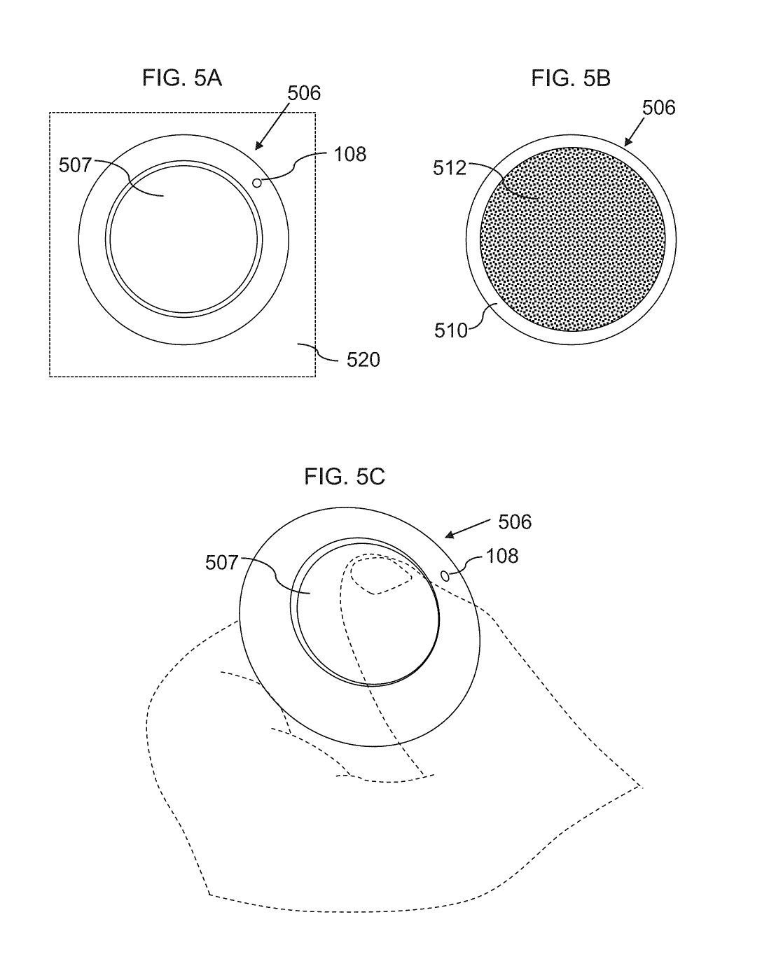

In a related embodiment, as shown in FIGS. 5A, 5B, 5C, a remote activation device 506 can be configured with solely one button 507.

In a related embodiment, the remote activation device 106 can be configured with a plurality of buttons 107 and the control system server 102 is configured with a plurality of control scripts, such that each button in the plurality of buttons is uniquely associated with a corresponding control script in the plurality of control scripts.

In a further related embodiment, the remote activation device 506 can be configured with a pressure sensitive adhesive 512 on a bottom 510 of the remote activation device 506, such that the remote activation device 506 can be positioned on a flat surface 520, such as a wall 520, as shown in FIG. 5A.

In related embodiments, the remote activation device 106 can include configurations as:
a) An electronic device, as shown in FIGS. 5A, 5B, and 5C;
b) A web application, executing in a Web browser;
c) A tablet app, executing on a tablet device, such as for example an Android or iOS tablet device;

d) A mobile app, executing on a mobile device, such as for example an

Android phone or iPhone, or any wearable mobile device;

e) A desktop application, executing on a personal computer, or similar device;

f) An embedded application, executing on a processing device, such as for example a smart TV, a game console or other system.

It shall be understood that an executing instance of an embodiment of the control system for script authoring and remote activation 100, as shown in FIGS. 1A and 1B, can include a plurality of remote activation device 106.

An executing instance of an embodiment of the control system for script authoring and remote activation 100, as shown in FIGS. 1A and 1B, can similarly include a plurality of control system servers 102.

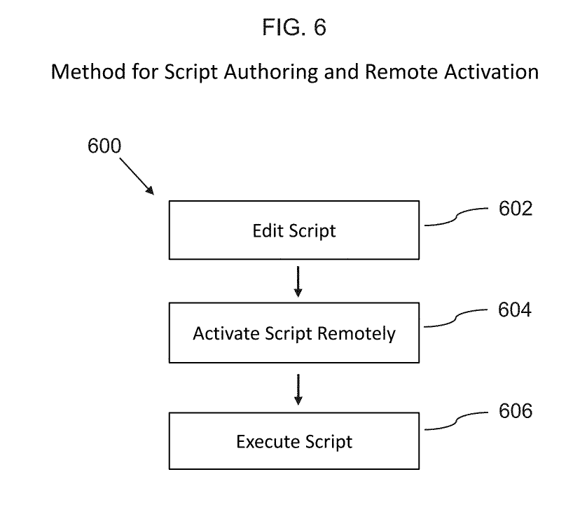

In an embodiment, as illustrated in FIG. 6, a method for script authoring and remote activation 600, can include:
a) Editing a control script 602, wherein a control script is created, edited, and saved, via use of a script editor 210, such that the control script is configured to execute at least one function on a control system server 102
b) Activating the control script remotely 604, wherein a button 107 is depressed on a remote activation device 106, such that the remote activation device 106 sends a button activation signal to the control system server 102; and
c) Executing the control script 606, wherein the control system server 102 executes the function when the button activation signal is received by the control system server 102;

FIGS. 1A, 1B, 2, 3, and 6 are block diagrams and flowcharts, methods, devices, systems, apparatuses, and computer program products according to various embodiments of the present invention. It shall be understood that each block or step of the block diagram, flowchart and control flow illustrations, and combinations of blocks in the block diagram, flowchart and control flow illustrations, can be implemented by computer program instructions or other means. Although computer program instructions are discussed, an apparatus or system according to the present invention can include other means, such as hardware or some combination of hardware and software, including one or more processors or controllers, for performing the disclosed functions.

In this regard, FIGS. 1A, 1B, 2, and 3 depict the computer devices of various embodiments, each containing several of the key components of a general-purpose computer by which an embodiment of the present invention may be implemented. Those of ordinary skill in the art will appreciate that a computer can include many components. However, it is not necessary that all of these generally conventional components be shown in order to disclose an illustrative embodiment for practicing the invention. The general-purpose computer can include a processing unit and a system memory, which may include various forms of non-transitory storage media such as random access memory (RAM) and read-only memory (ROM). The computer also may include nonvolatile storage memory, such as a hard disk drive, where additional data can be stored.

FIGS. 1A and 1B, each show a depiction of an embodiment of the control system for script authoring and remote activation 100, including the control system server 102, and the remote activation device 106. In this relation, a server shall be understood to represent a general computing capability that can be physically manifested as one, two, or a plurality of individual physical computing devices, located at one or several physical locations. A server can for example be manifested as a shared computational use of one single desktop computer, a dedicated server, a cluster of rack-mounted physical servers, a datacenter, or network of datacenters, each such datacenter containing a plurality of physical servers, or a computing cloud, such as AMAZON EC2™ or MICROSOFT AZURE™.

It shall be understood that the above-mentioned components of the control system server 102 and the remote activation device 106 are to be interpreted in the most general manner.

For example, the processors 202 302, can each respectively include a single physical microprocessor or microcontroller, a cluster of processors, a datacenter or a cluster of datacenters, a computing cloud service, and the like. In some embodiments, the remote activation device 106 may not include a processor 302, memory 304, and be configured with a wireless communication circuitry that is activated by the button 107.

In a further example, the non-transitory memory 204 and the non-transitory memory 304 can each respectively include various forms of non-transitory storage media, including random access memory and other forms of dynamic storage, and hard disks, hard disk clusters, cloud storage services, and other forms of long-term storage. Similarly, the input/output 206 and the input/output 306 can each respectively include a plurality of well-known input/output devices, such as screens, keyboards, pointing devices, motion trackers, communication ports, and so forth.

Furthermore, it shall be understood that the control system server 102 and the remote activation device 106 can each respectively include a number of other components that are well known in the art of general computer devices, and therefore shall not be further described herein. This can include system access to common functions and hardware, such as for example via operating system layers such as WINDOWS™, LINUX™, and similar operating system software, but can also include configurations wherein application services are executing directly on server hardware or via a hardware abstraction layer other than a complete operating system.

An embodiment of the present invention can also include one or more input or output components, such as a mouse, keyboard, monitor, and the like. A display can be provided for viewing text and graphical data, as well as a user interface to allow a user to request specific operations. Furthermore, an embodiment of the present invention may be connected to one or more remote computers via a network interface. The connection may be over a local area network (LAN) wide area network (WAN), and can include all of the necessary circuitry for such a connection.

In related embodiments, the remote activation device 106 communicates with the control system server 102 via a wireless network which can for example include Wi-Fi, BLUETOOTH™, ZIGBEE™, NFC, or proprietary RF communication. The communication can be transferred via a secure, encrypted communication protocol.

Typically, computer program instructions may be loaded onto the computer or other general-purpose programmable machine to produce a specialized machine, such that the instructions that execute on the computer or other programmable machine create means for implementing the functions specified in the block diagrams, schematic diagrams or flowcharts. Such computer program instructions may also be stored in a computer-readable medium that when loaded into a computer or other programmable machine can direct the machine to function in a particular manner, such that the instructions stored in the computer-readable medium produce an article of manufacture including instruction means that implement the function specified in the block diagrams, schematic diagrams or flowcharts.

In addition, the computer program instructions may be loaded into a computer or other programmable machine to cause a series of operational steps to be performed by the computer or other programmable machine to produce a computer-implemented process, such that the instructions that execute on the computer or other programmable machine provide steps for implementing the functions specified in the block diagram, schematic diagram, flowchart block or step.

Accordingly, blocks or steps of the block diagram, flowchart or control flow illustrations support combinations of means for performing the specified functions, combinations of steps for performing the specified functions and program instruction means for performing the specified functions. It will also be understood that each block or step of the block diagrams, schematic diagrams or flowcharts, as well as combinations of blocks or steps, can be implemented by special purpose hardware-based computer systems, or combinations of special purpose hardware and computer instructions, that perform the specified functions or steps.

As an example, provided for purposes of illustration only, a data input software tool of a search engine application can be a representative means for receiving a query including one or more search terms. Similar software tools of applications, or implementations of embodiments of the present invention, can be means for performing the specified functions. For example, an embodiment of the present invention may include computer software for interfacing a processing element with a user-controlled input device, such as a mouse, keyboard, touch screen display, scanner, or the like. Similarly, an output of an embodiment of the present invention may include, for example, a combination of display software, video card hardware, and display hardware. A processing element may include, for example, a controller or microprocessor, such as a central processing unit (CPU), arithmetic logic unit (ALU), or control unit.

Here has thus been described a multitude of embodiments of the control system for script authoring and remote activation 100, and methods related thereto, which can be employed in numerous modes of usage.

The many features and advantages of the invention are apparent from the detailed specification, and thus, it is intended by the appended claims to cover all such features and advantages of the invention, which fall within the true spirit and scope of the invention.

Many such alternative configurations are readily apparent, and should be considered fully included in this specification and the claims appended hereto. Accordingly, since numerous modifications and variations will readily occur to those skilled in the art, the invention is not limited to the exact construction and operation illustrated and described, and thus, all suitable modifications and equivalents may be resorted to, falling within the scope of the invention.

What is claimed is:

1. A control system for script authoring and remote activation, comprising:
a) a control system server;
b) a remote activation device, which comprises at least one button;
wherein the control system server is configured with a control script, such that the control script is configured to execute at least one function on the control system server;
wherein a button activation signal is transmitted to the control system server, when the at least one button is depressed by the user;
such that the control system server executes the at least one function when the button activation signal is received by the control system server.

2. The control system of claim 1, further comprising a wireless receiver;
such that the remote activation device communicates with control system server via the wireless receiver.

3. The control system of claim 2, wherein the wireless receiver is a part of the control system server.

4. The control system of claim 1, wherein the control system server further comprises:
a) a processor;
b) a non-transitory memory;
c) an input/output component; and
d) a script editor, which is configured to allow a user to create, edit, and save the control script.

5. The control system of claim 4, wherein the control system server further comprises:
a script executor, which is configured to execute the control script when a button activation signal is received by the control system server, such that the control system server executes the at least one function.

6. The control system of claim 1, wherein the at least one function comprises restarting the control system server.

7. The control system of claim 1, wherein the at least one function comprises turning off the control system server.

8. The control system of claim 1, wherein the at least one function comprises executing a selected application.

9. The control system of claim 1, wherein the at least one function comprises closing selected processes.

10. The control system of claim 1, wherein the at least one function comprises playing an audio file.

11. The control system of claim 1, wherein the audio file is configured to play a doorbell sound.

12. The control system of claim 1, wherein the remote activation device is configured with a plurality of buttons and the control system server is configured with a plurality of control scripts, such that each button in the plurality of buttons is uniquely associated with a corresponding control script in the plurality of control scripts.

13. The control system of claim 1, wherein the remote activation device is configured with a pressure sensitive adhesive on a bottom of the remote activation device, such that the remote activation device is configured to be positioned on a flat surface.

14. The control system of claim 4, wherein the script editor further comprises a simulation button, such that the script editor is configured to allow the user to do a test execution of the at least one function by depressing the simulation button.

15. A method for script authoring and remote activation, comprising:
a) editing a control script, wherein the control script is created, edited, and saved, via use of a script editor of a control system server, such that the control script is configured to execute at least one function on the control system server;
b) activating the control script remotely, wherein a button is depressed on a remote activation device, such that the remote activation device sends a button activation signal to the control system server; and
c) executing the control script, wherein the control system server executes the at least one function when the button activation signal is received by the control system server.

16. The control system of claim 15, wherein the control system server comprises:
a) a processor;
b) a non-transitory memory;
c) an input/output component; and
d) a script editor, which is configured to allow a user to create, edit, and save the control script.

17. The control system of claim 16, wherein the control system server further comprises:
a script executor, which is configured to execute the control script when a button activation signal is received by the control system server, such that the control system server executes the at least one function.

18. The control system of claim 15, wherein the at least one function comprises executing a selected application.

19. The control system of claim 15, wherein the at least one function comprises playing an audio file.

20. The control system of claim 19, wherein the audio file is configured to play a doorbell sound.
